(19) United States
(12) Patent Application Publication
(10) Pub. No.: US 2014/0058774 A1
(43) Pub. Date: Feb. 27, 2014

(54) BUSINESS PROCESS MANAGEMENT USING A REAL TIME STRATEGY GAME

(71) Applicants: Phaedra K. Boinodiris, Apex, NC (US); Brian C. DiCola, Chantilly, VA (US); Janis A. Morariu, Hardy, VA (US)

(72) Inventors: Phaedra K. Boinodiris, Apex, NC (US); Brian C. DiCola, Chantilly, VA (US); Janis A. Morariu, Hardy, VA (US)

(73) Assignee: INTERNATIONAL BUSINESS MACHINES CORPORATION, Armonk, NY (US)

(21) Appl. No.: 13/591,323

(22) Filed: Aug. 22, 2012

(51) Int. Cl. G06Q 10/06

(52) U.S. Cl. 705/7.12

(57) ABSTRACT

Aspects of the invention provide for business process management using a real time strategy game. In one embodiment, a system including a platform for business process management is provided. The system includes: a core operational real time strategy game for process improvement; a business process management system for receiving a business process model; and a real time data access and analytics system for tracking and analyzing real data of the core operational game and modifying, in response to the tracking, the business process model.

### TECHNICAL FIELD

The disclosure relates generally to business process management, and more particularly, relates to a system and method for business process management using a real time strategy game.

### BACKGROUND ART

Currently, industries are becoming more instrumented and complex, with logistics challenges and sub-optimized processes. As these industries become more complex, they continue to lack an effective collaboration and fail to implement efficient business processes. Industries also lack a system for optimizing the business processes.

In the past, a cost-effective, virtual, and engaging way to train individuals on a variety of different topics was through Serious Games. Serious Games are cross-genre videogames that teach or produce work that leverage the appeal that entertainment games include. Reward systems, storylines, collaboration, and competition are among the few appeal mechanisms that Serious Games use. Soldiers, physicians, and athletes, alike, have all been trained to develop specific skills using Serious Games. However, the resulting outcome of these Serious Games is one-dimensional, such that the individuals simply learn a process that is taught by the game.

### SUMMARY OF THE INVENTION

Aspects of the invention provide for business process management using a real time strategy game. In one embodiment, a system including a platform for business process management is provided. The system includes: a core operational real time strategy game for process improvement; a business process management system for receiving a business process model; and a real time data access and analytics system for tracking and analyzing real data of the core operational game and modifying, in response to the tracking, the business process model.

A first aspect of the invention provides a system including a platform for business process management, the platform comprising: a core operational real time strategy game for process improvement; a business process management system for receiving a business process model; and a real time data access and analytics system for tracking and analyzing real data of the core operational game and modifying, in response to the tracking, the business process model.

A second aspect of the invention provides a computer-implemented method for business process management, comprising: providing a core operational real time strategy game for process improvement; receiving a business process model; tracking real data of the core operational game; and modifying, in response to the tracking, the business process model.

A third aspect of the invention provides a computer program comprising program code embodied in at least one computer-readable storage medium, which when executed, enables a computer system to implement a method of business process management, the method comprising: providing a core operational real time strategy game for process improvement; receiving a business process model; tracking real data of the core operational game; and modifying, in response to the tracking, the business process model.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a system overview of a platform for business process management according to embodiments of the invention.

FIG. 2 shows a business process management system according to embodiments of the invention.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a system and method for business process management using a real time strategy game. As used herein, unless otherwise noted, the term “set” means one or more (i.e., at least one) and the phrase “any solution” means any now known or later developed solution.

Currently, industries are becoming more instrumented and complex, with logistics challenges and sub-optimized processes. As these industries become more complex, they continue to lack an effective collaboration and fail to implement efficient business processes. Industries also lack a system for optimizing the business processes.

In the past, a cost-effective, virtual, and engaging way to train individuals on a variety of different topics was through Serious Games. Serious Games are cross-genre videogames that teach or produce work that leverage the appeal that entertainment games include. Reward systems, storylines, collaboration, and competition are among the few appeal mechanisms that Serious Games use. Soldiers, physicians, and athletes alike, have all been trained to develop specific skills using Serious Games. However, the resulting outcome of these Serious Games is one-dimensional, such that the individuals simply learn a process that is taught by the game.

Aspects of the invention provide for business process management using a real time strategy game. In one embodiment, a system including a platform for business process management is provided. The system includes: a core operational real time strategy game for process improvement; a business process management system for receiving a business process model; and a real time data access and analytics system for tracking and analyzing real data of the core operational game and modifying, in response to the tracking, the business process model. By providing a gaming platform with collaboration capabilities, time manipulation, and business process management, businesses/clients will be able to better comprehend business process models and modify the business process models to be more efficient. Businesses/clients will be able to solve complex business process model problems and modify the business process models.

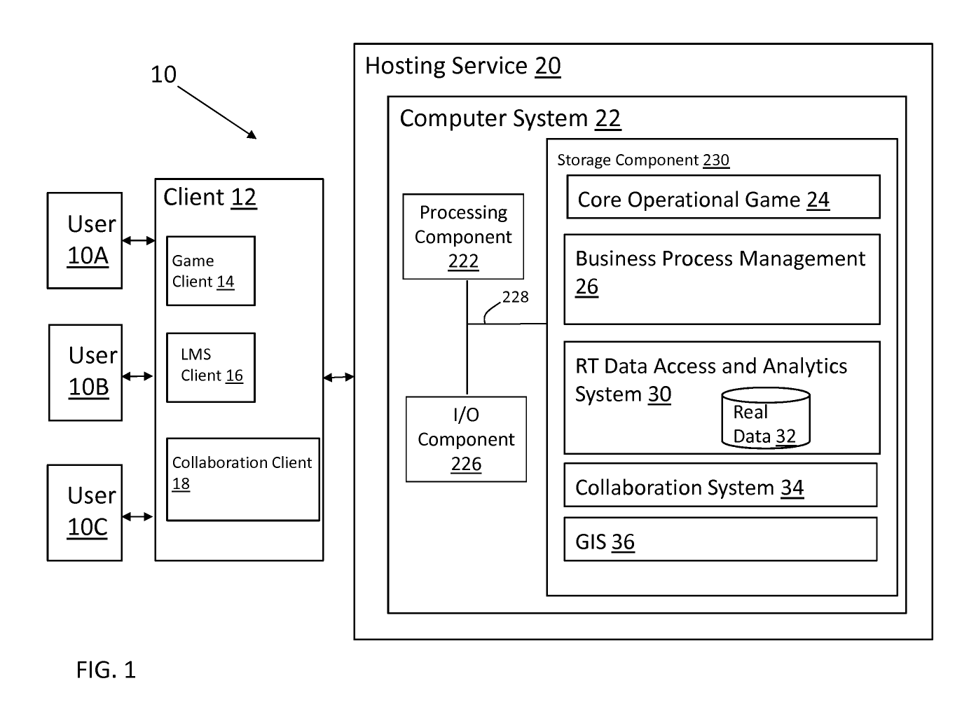

Turning to the drawings, FIG. 1 shows an illustrative environment 10 for business process management using a real time strategy game according to embodiments of the invention. To this extent, environment 10 includes a computer system 22 provided within/on a hosting service 20. Hosting service 20 may include any now known or later developed hosting service, such as, but not limited to a cloud service. Computer system 22 can perform a process described herein in order to manage a business process using a real time strategy game. In particular, computer system 22 is shown including, within storage component 230, a core operational game 24, a business process management system 26, a real time (RT) data access and analytics system 30, a collaboration system 34, and a geographic information system (GIS) 36, which makes computer system 22 operable to perform business process management using a real time strategy game by performing processes described herein.

Computer system 22 is shown including a processing component 222 (e.g., one or more processors), a storage component 230 (e.g., a storage hierarchy), an input/output (I/O) component 226 (e.g., one or more I/O interfaces and/or devices), and a communications pathway 228. In general, processing component 222 executes program code, such as code for core operational game 24, business process management system 26, RT data access and analytics system 30, collaboration system 34, and GIS 36, which are at least partially fixed in storage component 230. While executing program code, processing component 222 can process data, which can result in reading and/or writing transformed data from/to storage component 230 and/or I/O component 226 for further processing. Pathway 228 provides a communications link between each of the components in computer system 22. I/O component 226 can comprise one or more human I/O devices, such as users 10A, 10B, 10C to interact with computer system 22, via client 12. To this extent, users 10A, 10B, 10C to interact with core operational game 24, business process management 26, RT data access and analytics system 30, collaboration system 34, and GIS 36 via client 12.

In any event, computer system 22 (and/or client 12) can comprise one or more general purpose computing articles of manufacture (e.g., computing devices) capable of executing program code, such as core operational game 24, business process management 26, RT data access and analytics system 30, collaboration system 34, and GIS 36, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, core operational game 24, business process management 26, RT data access and analytics system 30, collaboration system 34, and GIS 36 can be embodied as any combination of system software and/or application software.

Further, core operational game 24, business process management 26, RT data access and analytics system 30, collaboration system 34, and GIS 36 can be modules that are implemented using computer system 22. In this case, each module can enable computer system 22 to perform a set of tasks used by each module, and can be separately developed and/or implemented apart from other modules. As used herein, the term “component” means any configuration of hardware, with or without software, which implements the functionality described in conjunction therewith using any solution, while the term “module” means program code that enables a computer system 22 to implement the actions described in conjunction therewith using any solution. When fixed in a storage component 230 of a computer system 22 that includes a processing component 22, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 22.

When computer system 22 comprises multiple computing devices, each computing device can have only one or more modules (core operational game 24, business process management 26, RT data access and analytics system 30, collaboration system 34, and GIS 36) fixed thereon. However, it is understood that computer system 22 and the modules thereon, are only representative of various possible equivalent computer systems that may perform a process described herein. To this extent, in other embodiments, the functionality provided by computer system 22 (and core operational game 24, business process management 26, RT data access and analytics system 30, collaboration system 34, and GIS 36) can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 22 includes multiple computing devices, the computing devices can communicate over any type of communications link. Further, while performing a process described herein, computer system 22 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

As discussed herein, each of the modules (core operational game 24, business process management 26, RT data access and analytics system 30, collaboration system 34, and GIS 36) enables computer system 22 to perform business process management using a real time strategy game.

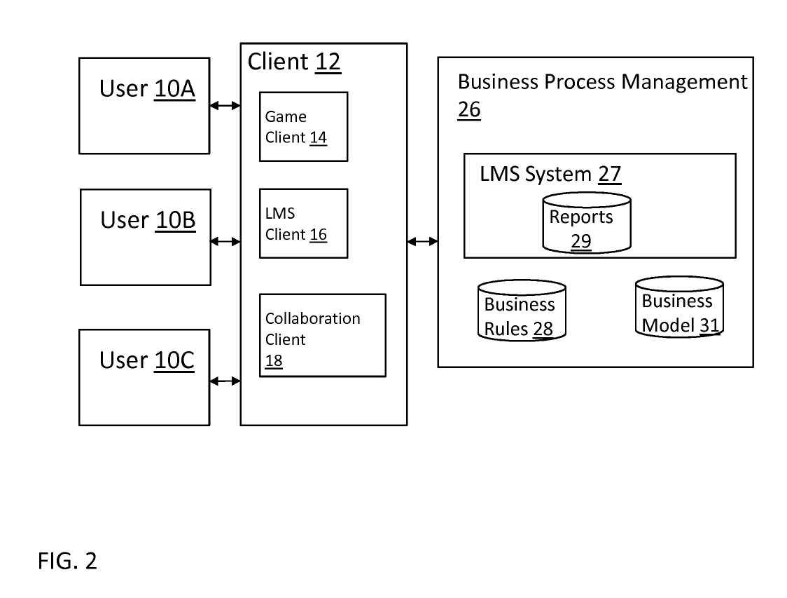

Turning now to FIG. 2, and with respect to FIG. 1, a business process management system according to embodiments of the invention is shown. It is understood that users 10A, 10B, 10C interact with core operational game 24 via a client 12 (and game client 14). Core operational game 24 is a real time strategy game for process improvement. For example, core operational game 24 may include any virtual world, real time strategy game, as known in the art. Core operational game 24 allows a user 10A, 10B, 10C to perform time manipulation, as known in the art.

Business process management system 26 is provided to receive a business process model 31. The real time data access and analytics system 30 is provided to track and analyze real data 32 of the core operational game 24, as a user 10A, 10B, 10C interacts with client 12. For example, in the field of education, the real data 32 may be statistics on how students are performing in the core operational game 24. In operation, core operational game 24 may generate a plurality of reports of the real data 32 tracked by the real data access and analytics system 30.

Based on the real time data 32, business process management 26 may also modify, in response to the tracking, the business process model 31. In this way, the business process model 31 may be optimized based on real time data 32. Business process management system 26 may also receive a plurality of business rules 28 from users 10A, 10B, 10C that are used for modifying the business process model 31. For example, business rules 28 may be rules that the business process model 31 is required to follow. This modified process model 31 may be provided to users 10A, 10B, 10C. Business process management 26 may also include a learning management system (LMS) 27 for generating a plurality of reports 29 for users 10A, 10B, 10C which are sent via LMS client 16.

A collaboration system 34 may also be provided for providing leader boards, forums, and web-based support, in order for users 10A, 10B, 10C to interact with one another (via collaboration client 18). Further, a geographical information system (GIS) 36 may also be provided for receiving location information.

While shown and described herein as a method and system for business process management, it is understood that aspects of the invention further provide various alternative embodiments. For example, in one embodiment, the invention provides a computer program fixed in at least one computer-readable medium, which when executed, enables a computer system to business process management. To this extent, the computer-readable medium includes program code, such as core operational game 24, business process management 26, RT data access and analytics system 30, collaboration system 34, and GIS 36 (FIG. 1), which enables a computer system 22 to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as core operational game 24, business process management 26, RT data access and analytics system 30, collaboration system 34, and GIS 36 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for business process management. In this case, a computer system, such as computer system 22 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to business process management as described herein. In this case, the service provider can manage (e.g., create, maintain, support, etc.) a computer system, such as computer system 22 (FIG. 1), that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A system including a platform for business process management, the platform comprising:
a hosting service;
a computer system provided by the hosting system, the computer system including:
a core operational real time virtual world strategy game for process improvement;
a business process management system for receiving a business process model;
a real time data access and analytics system for tracking and analyzing real data of the core operational game and modifying, in response to the tracking, the business process model to provide a modified business process model; and
a business rules management system for receiving a plurality of business rules, wherein the modified business process model is further based on the plurality of business rules;
a client for allowing a user to interact with the core operational real time strategy game and to send the plurality of business rules to the business rules management system, the client including:
a game client for connecting the user to the core operational real time strategy game;
a learning management system client for receiving and presenting to the user a plurality of reports of the real data tracked by the real time data access and analytics system; and
a collaboration client for presenting leader boards, forums, and web-based support to the user.

2. (canceled)

3. The system of claim 1, further comprising a collaboration system for providing the leader boards, forums, and web-based support.

4. The system of claim 1, the real time data access and analytics system further comprising a geographical information system (GIS) for receiving location information.

5. The system of claim 1, wherein the core operational real time strategy game generates the plurality of reports of the real data tracked by the real time data access and analytics system.

6. The system of claim 1, wherein the modified business model is provided to the user via the client.

7. (canceled)

8. A computer-implemented method for business process management, comprising:
providing a core operational real time virtual world strategy game for process improvement;
receiving, by a business processes management system, a business process model;
tracking, by a real time data access and analytics system, real data of the core operational game;
modifying, by the real time data access and analytics system, in response to the tracking, the business process model to provide a modified business process model;
receiving, by a business rules management system, a plurality of business rules from a user, wherein the modified business process model is further based on the plurality of business rules;
interacting, by the user via a client, with the core operational real time strategy game and sending the plurality of business rules to the business rules management system;
connecting, via a game client, the user to the core operational real time strategy game;
receiving and presenting to the user, by a learning management system client, a plurality of reports of the real data tracked by the real time data access and analytics system; and
presenting, via a collaboration client, leader boards, forums, and web-based support to the user.

9. (canceled)

10. The method of claim 8, further comprising providing the leader boards, forums, and web-based support.

11. The method of claim 8, further comprising receiving, from a geographical information system (GIS), location information.

12. The method of claim 8, further comprising generating the plurality of reports of the real data tracked by the core operational game.

13. The method of claim 8, further comprising providing the modified business process model to the user via the client.

14. (canceled)

15. A computer program comprising program code embodied in at least one computer-readable medium, which when executed, enables a computer system to implement a method of business process management, the method comprising:
providing a core operational real time virtual world strategy game for process improvement;
receiving, by a business processes management system, a business process model;
tracking, by a real time data access and analytics system, real data of the core operational game;
modifying, by the real time data access and analytics system, in response to the tracking, the business process model to provide a modified business process model;
receiving, by a business rules management system, a plurality of business rules from a user, wherein the modified business process model is further based on the plurality of business rules;
interacting, by the user via a client, with the core operational real time strategy game and sending the plurality of business rules to the business rules management system;
connecting, via a game client, the user to the core operational real time strategy game;
receiving and presenting to the user, by a learning management system client, a plurality of reports of the real data tracked by the real time data access and analytics system; and
presenting, via a collaboration client, leader boards, forums, and web-based support to the user.

16. (canceled)

17. The computer program of claim 15, further comprising providing the leader boards, forums, and web-based support.

18. The computer program of claim 15, further comprising generating the plurality of reports of the real data tracked of the core operational game.

19. The computer program of claim 15, further comprising providing the modified business process model to the user via the client.

20. (canceled)

21. The computer program of claim 15, further comprising receiving, from a geographical information system (GIS), location information.
